(19) United States
(12) Patent Application Publication
(10) Pub. No.: US 2024/0342557 A1
(43) Pub. Date: Oct. 17, 2024

(54) AI-Powered Robotic Defender for Performance Analysis and Advanced Sports Training

(71) Applicant: Archana Balkrishna Yadav, Vadodra (IN)

(72) Inventor: Archana Balkrishna Yadav, Vadodra (IN)

(21) Appl. No.: 18/747,223

(22) Filed: Jun. 18, 2024

(51) Int. Cl. A63B 24/00; A63B 69/00; A63B 71/06; A63B 102/24; B25J 9/16

(52) U.S. Cl. CPC A63B 24/0075; A63B 24/0062; A63B 69/002; A63B 71/0605; A63B 71/0622; B25J 9/163; A63B 2102/24; A63B 2243/0025; A63B 2243/007

(57) ABSTRACT

The present invention discloses an AI-powered system integrating robotic defenders and advanced performance analysis to revolutionize sports training and strategy. The system includes robotics mechanical defender or defender in a wall, equipped with imaging or video apparatus, high-precision sensors and machine learning algorithms to simulate realistic and dynamic opponents. It also features striker scan technology that analyzes historical player data to predict shot selection and actions, providing strategic insights. An AI-driven training tools offer personalized regimens and real-time feedback, enhancing skill development. This comprehensive system improves player performance and team strategy across various sports by offering consistent, challenging practice scenarios and detailed tactical analysis. The system can be implemented in any ball game needing defenders.

### TECHNICAL FIELD

The present invention relates to the field of training and more particularly to an AI based sports training.

### BACKGROUND

The following description includes information that may be useful in understanding the present invention. It is not an admission that any of the information provided herein is prior art or relevant to the presently claimed invention, or that any publication specifically or implicitly referenced is prior art.

In the realm of competitive sports, achieving excellence requires not only natural talent but also rigorous training, strategic planning, and continuous performance improvement. Traditional training methods, while foundational, often lack the precision and adaptability needed to address the dynamic nature of modern sports. Coaches and athletes rely heavily on observational techniques and historical data to devise strategies and improve skills. However, these methods can be subjective and limited by human capacity to process and react to vast amounts of data.

Athletes often face variability in the quality and intensity of their training sessions. Human defenders and training partners can vary in skill and consistency, leading to uneven practice conditions that can affect an athlete's development. Coaches and analysts are inundated with extensive amounts of performance data. Analyzing this data manually to extract actionable insights is time-consuming and prone to errors, making it difficult to implement effective strategies promptly.

Understanding and anticipating the actions of opponents is crucial for developing effective defensive and offensive strategies. However, accurately predicting these behaviors based on past performances can be challenging without advanced analytical tools. Athletes need to develop their skills under conditions that closely mimic actual game scenarios. Traditional training often falls short in replicating the high-pressure, fast-paced environment of a real match, limiting the effectiveness of practice sessions.

One notable prior art in the field of sports training equipment is the Pro Training Defender. This durable, lightweight six-foot mannequin is designed to help athletes improve various skills such as passing, dribbling, shooting, and goalkeeping. It features a wide base and a unique rotational design, ensuring that the defender remains upright even through hard hits and windy conditions. The Pro Training Defender is engineered for stability and durability, making it a reliable training tool for repetitive, high-impact drills. Additionally, it is designed for convenience, breaking down to 3.5 feet for easy transportation to and from the field. While the Pro Training Defender provides a robust and practical solution for enhancing fundamental soccer skills, it primarily focuses on physical stability and case of transport. It does not incorporate a more sophisticated system that can offer personalized feedback, predictive analytics, and realistic, variable training conditions to better prepare athletes for the complexities of real-game situations.

WO2020193771A1 titled “Barrier arrangement, method and application software for free kick practice” by Bernardo Laulhé discloses A barrier arrangement, a method and an application software for the practice of free kicks, comprising: a barrier formed by a plurality of barrier bodies (1) in the form of human-like figurines mounted in a substantially vertical position in a frame or skeleton forming a mobile structure (26), and actuator mechanisms (3, 15) linking the figurines with the mobile structure to provide them with an upward and downward movement. The arrangement also comprises video camera sets (56), a set of communications cabinet and a portable command and programming terminal (74) provided with an application software, wherein the portable terminal communicates to the barrier assembly through wireless communication to and from the communications cabinet assembly. The application software of the invention comprises a computer application program (APR) product that provides new features for the barrier arrangement. However, the application failed to disclose the artificial intelligence and machine learning to enhance training of the defender(s) as described in the application below.

WO2020076151A1 titled “A free-kick wall system” by Freekickpro Holding B V discloses a free-kick wall system comprising: —a movable free-kick wall for mimicking a wall of players when taking a free-kick on a playing field; —a data register unit comprising historical data related to a plurality of historical free-kicks, preferably using said movable free-kick wall; —a data collecting unit, communicatively coupled to said data register unit, arranged for collecting data related to a free-kick to be taken using said moveable free-kick wall; —a determining unit, communicatively coupled to said data register unit, arranged for determining free-kick parameters for said free-kick to be taken taking into account said historical data and data collected related to said free-kick to be taken; and —a proposal unit, communicatively couple to said determining unit, arranged for providing a proposal to a user of the free-kick wall system for taking and/or blocking said free-kick to be taken. However, the application failed to disclose the artificial intelligence and machine learning to enhance training of the defender(s) as described in the application below.

To overcome these challenges, there is a pressing need for innovative solutions that bring consistency, precision, and real-time adaptability to sports training and strategy. In light of these challenges and drawbacks, there exists a compelling opportunity for innovative solutions that address the limitations. As a result, there exists a need for improvements over the prior art and more particularly for a more efficient way.

### SUMMARY OF THE INVENTION

This invention revolutionizes sports training and strategic planning by introducing an advanced AI-powered system that integrates robotic defenders and sophisticated performance analysis tools. The system incorporates both mechanical and robotic defenders to provide a comprehensive training experience. The mechanical defender is a physical robotic system designed to replicate human defensive actions. Equipped with high-precision sensors and actuators, it offers realistic and dynamic defensive challenges during training sessions. Further, the robotic defender utilizes sophisticated algorithms and machine learning to predict and respond to player movements in real-time. This adaptive component ensures a versatile and intelligent defensive presence on the field, adjusting its strategies and movements based on real-time data to offer player a continuously challenging environment to prepare for the real-quest.

A key feature of the system is its striker scan and analysis tool. By compiling extensive historical data on striker players, including past performances, shooting accuracy, and behavioral patterns, the system develops probability models to forecast future actions and outcomes. This predictive analytics capability enables teams to devise targeted defensive strategies, better anticipate offensive plays, and make informed decisions during games.

The invention incorporates AI-driven training tools to personalize training regimens and simulate various game scenarios to train and improve performance. The AI based system analyzes individual player performance to identify strengths and weaknesses, creating customized training programs tailored to each athlete's needs. These tools enable athletes to practice and refine their skills in a controlled environment closely mirroring real-game conditions, ultimately leading to significant improvements in performance.

To simulate high-pressure game scenarios, the system includes a robotic defender specifically designed to replicate a human goalkeeper or player in the wall in free-kick scenario and penalty kick practice. This component reacts to shots with high precision, providing strikers with a challenging and realistic practice partner. Additionally, AI offers instant feedback on each penalty kick, providing suggestions for improvement and adjustments to enhance success rates. The AI system further configured to react as per specific player traits.

Robotic models serve as reliable and consistent training partners, simulating different levels of difficulty and playing styles. By replicating high-pressure, fast-paced game scenarios, these models help players improve their decision-making and performance under stress, ensuring they are better prepared for the complexities of actual game situations.

The summary of the invention does not necessarily disclose all the features essential for defining the invention. The invention may reside in a sub-combination of the disclosed features. The various combinations and sub-combination are fully described in the detailed description.

### BRIEF DESCRIPTION OF DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

The diagrams are for illustration only, which thus is not a limitation of the present disclosure, and wherein:

FIG. 1 illustrates a block diagram illustrating the components of an AI-powered robotic based performance analysis system for advanced sports training system, in accordance with a preferred embodiment of the invention.

FIGS. 2A and 2B illustrates an example of AI-Powered robotic based performance analysis system for advanced sports training, in accordance with a preferred embodiment of the invention.

### DETAILED DESCRIPTION OF DRAWINGS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure.

An artificial intelligence (AI) based performance analysis and sports training system is disclosed. A robotic mechanical defender or plurality of defenders in a defense wall, equipped with one or more cameras preferably in the chest of the defender, one or more sensors such as gyro-sensors, accelerometers, ball tracking sensor, gesture sensor etc. and one or more actuator to simulate defensive actions in response to detection of free kick by a striker.

The system further comprises an advanced robotics components and the sensors for precise movement of the robotic mechanical defender.

A machine learning unit configured to analyze sensor data and predict player actions in real-time, such actions can be movement of players, direction of player's feet to determine the direction of a shot.

A real-time processing unit to execute decision-making algorithms and computer vision algorithms to determine the direction of the ball.

A striker scan and analysis tool for collecting and analyzing historical performance data of striker, data related to the direction of strikes, speed, curl or passing-on to other player. The historical performance data can be collected from the online web portals, official tournament data, club stats, or can be manual inputted by the coaching staff.

An AI-driven training tool for generating personalized training based on striker scan and movement of the robotic mechanical defender and providing a real-time feedback to the striker.

An adaptive AI coaching module for delivering personalized coaching advice based on real-time performance and feedback data from AI driven training tool, wherein the machine learning unit and adaptive AI coaching module collaborate to adjust training regimens and coaching advice dynamically for each striker, based on real-time sensor data from robotic mechanical defender(s) for improving the performance of the striker in a real match.

The AI based robotic defender further comprising audio output system to challenge the striker with motivating or enticing words such as come-on, you can do this, curl around me, give your best, I am better than you, let's see what you got or mimic like an opponent.

The system comprises of block chain technology to securely store encrypted performance data, training progress, and injury history in a decentralized ledger, ensuring immutable records, transparent access controls, automated smart contract execution for incentives, and cryptographic data verification, thereby enhancing transparency, privacy, integrity, and accountability within the sports training ecosystem.

The system, further comprising a user interface featuring an intuitive dashboard that provides coaches and players with real-time analytics and AI-generated insights into gameplay strategies and performance metrics; wherein, the intuitive dashboard facilitates immediate feedback on tactical decisions and player actions during training sessions; and further
enables comprehensive analysis of team dynamics and individual player development, empowering coaches to customize training sessions based on specific skill areas, tactical adjustments, and strategic improvements.

Further, the user interface also allows the coaching or player to customize the robotic mechanical defender or defender wall to practice or train a particular scenario. The scenario can be chosen by the coaching staff or by the player.

The robotic mechanical defender includes a robotic arm or leg or head for head, and leg movement or upward or downward movement, capable of adjusting its position and movements in response to player interactions. Further, the defender can also takes the place of a goal keeper for arm movement in response to the striker's strike.

The robotic mechanical defender is configured to simulate various types of offensive plays and player actions to provide realistic training scenarios and improving player performance by providing challenging environment.

The system comprising a cloud-based analytics platform to centralize and analyze training data from multiple sources.

The system also works in the decentralized manner, where all the data collected is stored in a block chain ledger.

The AI-driven training tool simulates game scenarios and provides instant feedback using a screen on player performance to enhance skill development.

The system utilizes gesture recognition by recognizing the movement of the feet, hand or other body postures or movement, to track and analyze player and ball movements.

A method for artificial intelligence (AI) based performance analysis and sports training, comprising the steps of collecting real-time sensor data from camera, one or more sensor and actuators in a robotic mechanical defender; analyzing the collected sensor data with machine learning algorithms and predict player action; collecting and analyzing striker data from historical performances and determining the side, shape, height, shot speed, and turn on the ball by the player; generating personalized feedback and coaching advice based on the analyzed data and shot output; and providing player with individualized skill development plans and real-time feedback during training sessions with AI driven training tool and coaching module.

The step of using a mechanical defender to simulate defensive actions and pose challenging scenarios for player during training drills.

The step of simulating offensive plays using a robotic defender to provide realistic training scenarios for defensive players and proving realistic training scenario for offensive players using artificial intelligence and robotics.

The step of using striker scan and analysis tools to develop probability models based on historical performance data of offensive players and real-time sensor data.

The adaptive AI coaching module interacts with player to deliver personalized coaching advice and adjust training plans based on real-time performance feedback.

The collected performance data includes metrics such as speed, accuracy, direction, judgement, reaction time, and decision-making proficiency.

The step of integrating virtual reality or augmented reality to create immersive training environments for player.

A robotic mechanical defense wall for training free-kicks or spot kicks, comprising one or more robotics mechanical defenders equipped with a camera, a plurality of sensors and actuators to simulate defensive actions; a real-time processing unit configured to execute defensive maneuvers based on sensor input; a machine learning module for analyzing shot and historical performance data of a striker and predicting offensive player actions; an AI-driven training tool for generating personalized training based on striker scan and movement of the robotic mechanical defender and providing a real-time feedback to the striker; and an adaptive AI coaching module that provides personalized feedback and training recommendations based on real-time performance data and historical performance data;

The adaptive AI coaching module utilizes natural language processing to facilitate interactive coaching sessions and provide detailed, personalized advice to player.

The sport can be any sport related to ball game such as Football, Hockey, Soccer or any other ball game.

The robotic mechanical defender poses a challenging scenario for the player practicing in the training game.

The robotic mechanical defender utilizing actuators to move head, legs for jump or no jump movement.

The robotic mechanical defense wall apparatus utilizes Artificial Intelligence, Robotics, Machine Learning and Computer vision in determining ball movement, striker's foot direction or movement, speed of ball, curve on the ball and generate reaction from the robotic mechanical defender to stop or divert the shot.

The size, shape, movement or jump or no jump of the robotic mechanical defender can be altered based on the opponent, a striker is preparing against and the robotic mechanical defender in the wall can act individually or collectively.

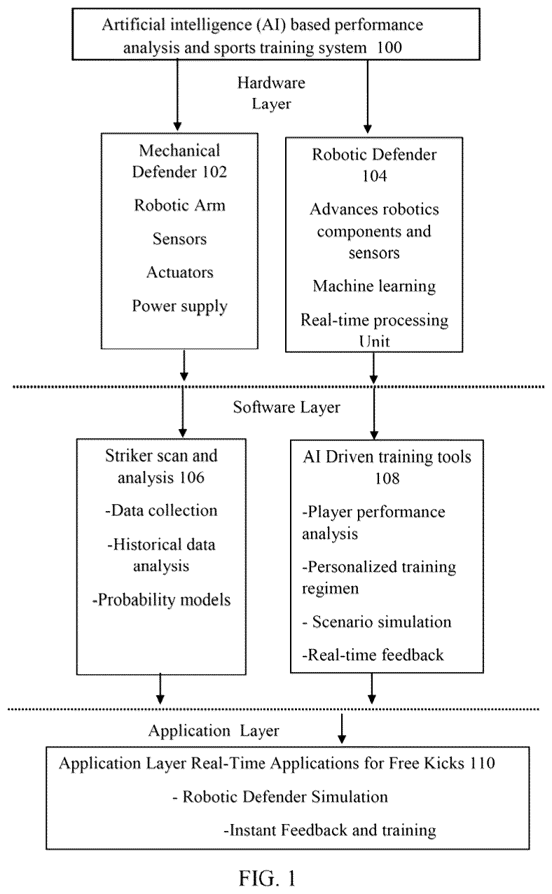

FIG. 1 illustrates a block diagram illustrating the components of an AI-powered robotic based performance analysis system for advanced sports training system (100), in accordance with a preferred embodiment of the invention.

Mechanical Defender (102): The Mechanical Defender represents a pivotal hardware component within the sports training system. Comprising a robotic arm equipped with sophisticated sensors and actuators, it emulates human defensive actions on the field during training sessions. The robust design ensures stability and durability, crucial for enduring high-impact interactions. Sensors integrated into the arm detect player movements and ball trajectories, enabling precise and responsive actions. Actuators facilitate physical movements, allowing the defender to dynamically interact with players and the ball. Additionally, a reliable power supply ensures continuous operation throughout training sessions, providing consistent challenges and opportunities for skill development.

Robotic Defender (104): The Robotic Defender stands as an advanced hardware component, leveraging cutting-edge robotics technology to enhance sports training. Featuring an array of advanced robotics components and sensors, it boasts precise movements and interactions with players and the ball. A dedicated machine learning unit analyzes sensor data in real-time, predicting and responding to player actions with unparalleled accuracy. This adaptive capability ensures a dynamic and intelligent defensive presence on the field, adapting strategies swiftly to match changing conditions. Moreover, a real-time processing unit executes decision-making algorithms swiftly, facilitating seamless interaction with players during training sessions.

Striker Scan & Analysis (106): Within the software layer, the Striker Scan & Analysis component plays a pivotal role in gathering and analyzing data critical for strategic planning and player development. It systematically collects extensive historical data on offensive players, including past performances and behavioral patterns. This data undergoes thorough analysis to develop probability models, predicting future actions and outcomes. These insights empower coaches and teams to formulate targeted defensive strategies and game plans, optimizing performance and competitive edge. The Striker Scan & Analysis component thus serves as a cornerstone for informed decision-making and tactical mastery.

AI-Driven Training Tools (108): The AI-Driven Training Tools represent a sophisticated software component designed to personalize training regimens and simulate real-game scenarios. Leveraging advanced algorithms, these tools analyze individual player performance to identify strengths and weaknesses accurately. Based on this analysis, personalized training programs are crafted to address specific needs and maximize skill development. Additionally, the tools simulate various game scenarios, offering players opportunities to refine their skills and decision-making under different conditions. Real-time feedback further enhances training effectiveness, enabling players to adapt and improve rapidly.

Real-Time Applications for Penalty Kicks (110): At the application layer, Real-Time Applications for Penalty Kicks offer invaluable opportunities for focused training and skill refinement. This component includes a Robotic Goalkeeper Simulation, replicating the actions of a human goalkeeper during penalty kick practice. Players engage in realistic scenarios, receiving instant feedback on their performance. This feedback enables quick adjustments and skill improvement, enhancing confidence and accuracy during actual game situations. Real-Time Applications for free or spot kicks thus provide targeted training experiences, sharpening players' abilities and preparing them for high-pressure moments on the field.

The collaboration between the machine learning unit and adaptive AI coaching module in the sports training system is pivotal for enhancing the simulation of dynamic interactions between teammates and opponents during training sessions. The machine learning unit serves as the analytical backbone of the system, continuously processing real-time sensor data from both the robotic defender and offensive players. This data includes metrics such as player movements, positioning, response times, and tactical decisions captured through embedded sensors and actuators.

As the machine learning unit analyzes this incoming data, it employs sophisticated algorithms to predict player actions and assess performance trends. For instance, it can detect patterns in defensive movements simulated by the robotic defender, such as tackling techniques or defensive coverage strategies. Simultaneously, it gathers historical performance data from offensive players using the striker scan and analysis tools, identifying strengths, weaknesses, and tendencies in their gameplay.

The adaptive AI coaching module complements this process by leveraging the insights generated by the machine learning unit. Drawing from real-time sensor data and historical performance analyses, the AI coaching module dynamically adjusts training regimens and coaching advice. It tailors these adjustments based on specific performance metrics observed during the training session, such as defensive efficiency, offensive creativity, or strategic adaptability.

Moreover, the AI coaching module's adaptive nature enables it to respond in real-time to fluctuations in player performance and training objectives. For example, if the robotic defender consistently demonstrates vulnerabilities in certain defensive scenarios, the AI coaching module may recommend drills focused on improving those specific skills. Conversely, if offensive players exhibit patterns of play that exploit these vulnerabilities, the module may adjust defensive strategies or simulate new scenarios to challenge and refine defensive techniques.

By integrating these functionalities, the sports training system not only simulates realistic interactions between teammates and opponents but also optimizes training sessions for individual player development and team cohesion. The collaborative effort between the machine learning unit and adaptive AI coaching module ensures that coaching interventions are data-driven, personalized, and responsive to the evolving dynamics of each training session. This approach enhances the system's capability to simulate dynamic gameplay scenarios effectively, providing a valuable tool for coaches and players aiming to improve performance across various competitive sports contexts.

In another aspect of the invention, the invention can be applied across various sports to enhance athlete performance and strategic planning like soccer, football, basketball, hockey etc. For example, Soccer teams can utilize the system to train defenders by simulating realistic defensive scenarios, such as one-on-one situations, crosses, and corner kicks. The robotic defender can adapt its movements based on the attacker's actions, providing dynamic challenges for defenders to overcome. Goalkeepers or defenders in a wall in game of football or Hockey can benefit from the real-Time Applications for free kicks, penalties or spot kicks, where they face simulated penalty shots from a robotic striker. Instant feedback helps goalkeepers refine their positioning, timing, and decision-making under pressure.

Coaches can use the Striker Scan & Analysis component to analyze opponents' offensive patterns and tendencies. This data can inform defensive strategies, such as marking specific players or adjusting defensive formations based on the opponent's preferred attacking routes.

In another embodiment of the invention, the sports training system incorporates a sophisticated user interface, featuring an intuitive dashboard designed to enhance the training experience for coaches and players alike. This dashboard serves as a centralized platform, providing real-time analytics and AI-generated insights into various aspects of gameplay strategies and performance metrics. Coaches can access detailed data on player movements, positioning, decision-making patterns, and performance metrics derived from sensors embedded in equipment and wearable devices used during training sessions. The intuitive dashboard plays a crucial role in facilitating immediate feedback during training sessions. It enables coaches to monitor and analyze tactical decisions made by players in real-time. For instance, coaches can observe how players react to simulated defensive actions by the robotic defender or analyze offensive strategies based on historical performance data collected by the striker scan and analysis tools. This real-time feedback mechanism allows coaches to intervene promptly, offering corrections, adjustments, or reinforcement of strategic concepts to enhance player understanding and execution on the field.

Moreover, the intuitive dashboard supports comprehensive analysis of team dynamics and individual player development over time. By aggregating and visualizing performance data, the dashboard empowers coaches to conduct in-depth evaluations of player or opponent's strengths, weaknesses, and progress across various skill areas. Coaches can identify patterns, trends, and areas for improvement, which are crucial for customizing training sessions to address specific player needs and team objectives. Furthermore, the dashboard facilitates strategic planning and adjustments for training regimens. Coaches can use the insights gleaned from real-time analytics and historical performance data to tailor training sessions. They can implement targeted drills, tactical exercises, and strategic simulations aimed at improving specific skill areas, refining team tactics, and achieving strategic improvements that align with competitive goals. This customization not only optimizes player development but also enhances team cohesion and performance readiness for competitive engagements.

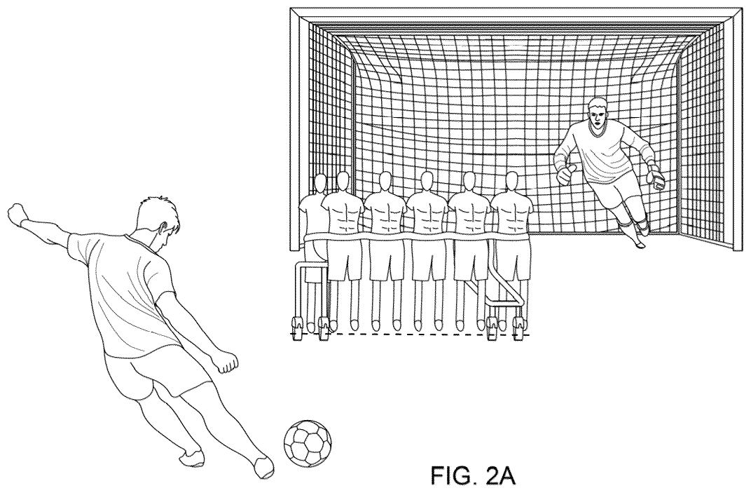

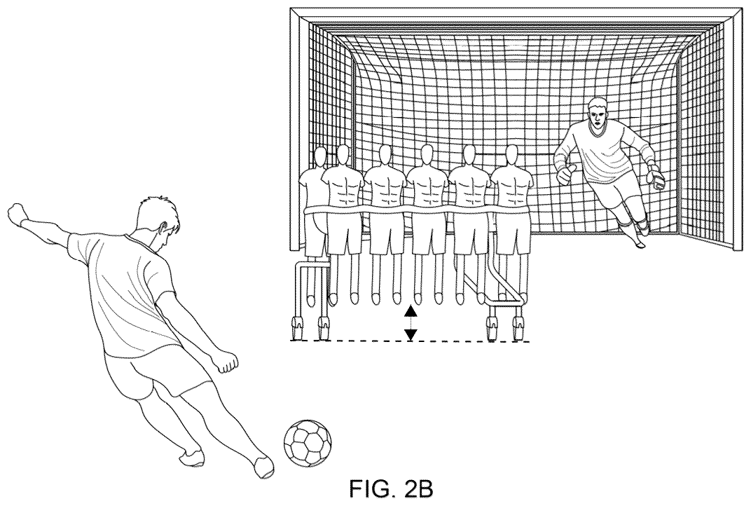

FIGS. 2A and 2B illustrates an example of AI-Powered robotic based performance analysis system for advanced sports training, in accordance with a preferred embodiment of the invention.

Using AI-Powered Defensive Mannequin for training. The advanced defensive mannequin or defender(s) are designed to enhance or improve training through the use of artificial intelligence and machine learning.

FIG. 2A illustrates the robotics mechanical defender in a wall, in lowered position, reacting to a low shot attempt in response to the striker's interaction with the ball or before the striker's takes the shot.

FIG. 2B shows the robotics mechanical defender in a wall, in an elevated position, defending against a high shot in response to the striker's interaction with the ball.

Utilizing AI, the system analyzes the striker's past performance history to predict where the striker is likely to aim the football and at what height. This predictive capability allows the robotics mechanical defender in a wall to dynamically adjust its position to better simulate real-match defense scenarios, providing a highly effective training tool for striker and defenders.

The robotics mechanical defender in a wall is specifically designed to mimic the actions of a real defender(s), offering player better visual training. In addition, the robotics mechanical defender(s) incorporates a durable aluminum center spine, which adds to its strength and stability, ensuring it can withstand rigorous training sessions.

The advanced training robotics mechanical defender in a wall is designed to significantly enhance sports training by not only simulating the presence of a defender but also by actively responding to player actions. This robotics mechanical defender is capable of human-like movements, such as bending, tilting, and reacting to stop the ball individually or collectively, similar to a defender in a real-match.

A camera placed in the head or chest or top portion of the robotics mechanical defender, offers a high vantage point, providing a broad field of view to capture the overall movements of the striker. This camera records the player's approach, movements, and interactions with the robotics mechanical defender. It is particularly useful for tracking actions like dribbling, passing, and shooting, providing a comprehensive overview of the player's tactics and strategies.

A camera embedded in the chest area captures detailed upper body movements and ball interactions. It helps coaches and players identify specific areas for improvement by focusing on the player's hands, arms, and ball handling techniques. The chest camera also tracks the player's eye level and line of sight during interactions, providing insights into their decision-making processes.

In another embodiment, another or second camera installed near the base of the robotics mechanical defender, facing goal, captures output of the shot whether goal or not and body movements of the keeper.

This front and back camera provides a different perspective, complementing the views by focusing on the striker's and Keeper's body mechanics. It is essential for understanding how players move their feet during shots. This comprehensive analysis of the player's entire body movement enhances the training experience.

Equipped with advanced robotics, the robotics mechanical defender can dynamically respond to striker's actions. It includes actuators and sensors that allow it to bend, tilt, and move in real-time, mimicking the actions of a human defender or goalkeeper. When a player attempts to shot passing the defender in a wall, the robotics mechanical defender can react by adjusting its head or jump position and timing, or bend to block shots, and tilting to intercept the ball.

This dynamic response mechanism makes training sessions more realistic and challenging, helping player or striker to develop better reflexes, accuracy, and strategic thinking.

The integrated cameras and sensors collect data during training sessions, which is processed in real-time by AI algorithms. This data provides detailed feedback on player performance, highlighting strengths and areas for improvement. The system can analyze metrics such as speed, accuracy, reaction time, and decision-making proficiency. By offering real-time feedback, the mannequin allows coaches to review footage and correct techniques immediately, providing targeted advice to players.

Blockchain technology plays a crucial role in enhancing transparency, data integrity, privacy and accountability within the ecosystem. At its core, block chain operates as a decentralized ledger where encrypted performance data, training progress updates, and injury histories are securely stored. Unlike traditional centralized databases, block chain ensures that this information is distributed across a network of computers (nodes), making it resistant to tampering and unauthorized access. The immutability of block chain records is a key feature. Each transaction or update to the data, whether it's a player's performance metrics or medical treatment history, is cryptographically secured and recorded as a block within the chain. Once recorded, these blocks cannot be altered retroactively without consensus from the network participants, ensuring data integrity and preventing fraudulent activities or data manipulation.

Access to the stored data is managed through encrypted, permissioned access keys. Players, coaches, medical staff, and management can securely access specific information based on their roles and permissions within the system. This transparency not only fosters trust among stakeholders but also facilitates informed decision-making processes regarding training regimes, injury management strategies, and performance assessments. Blockchain technology also facilitates the automation of certain processes through smart contracts. These self-executing contracts are programmed to trigger actions automatically when predefined conditions are met. In the context of sports training, smart contracts can manage incentive structures such as performance-based bonuses or milestone achievements related to injury recovery.

This automation reduces administrative overhead, enhances efficiency, and ensures that contractual terms are enforced transparently and impartially. Furthermore, cryptographic hashing algorithms are employed within the block chain to verify the authenticity and accuracy of stored data. Each piece of data is hashed into a unique string of characters, and any alteration to the data would result in a different hash value. By regularly verifying these hashes, stakeholders can ensure that the information stored within the block chain remains consistent and reliable, further reinforcing the system's accountability and trustworthiness.

The integration of mechanical and robotic defenders with AI-driven analysis tools offers numerous benefits:
Enhanced Performance: Players receive precise, real-time feedback and personalized training programs, leading to significant improvements in their skills and overall performance.
Strategic Superiority: Teams can analyze opponent behavior more accurately and develop more effective game plans, gaining a strategic edge over competitors.
Realistic Training Scenarios: The system provides a highly realistic and dynamic training environment, better preparing players for the complexities of actual game situations.
Consistency and Reliability: Robotic models ensure consistent training quality, reducing variability and enhancing the effectiveness of practice sessions.

As used herein, the term engine refers to software, firmware, hardware, or other component that can be used to effectuate a purpose. The engine will typically include software instructions that are stored in non-volatile memory (also referred to as secondary memory). When the software instructions are executed, at least a subset of the software instructions can be loaded into memory (also referred to as primary memory) by a processor. The processor then executes the software instructions in memory. The processor may be a shared processor, a dedicated processor, or a combination of shared or dedicated processors. A typical program will include calls to hardware components (such as I/O devices), which typically requires the execution of drivers. The drivers may or may not be considered part of the engine, but the distinction is not critical.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

While the subject invention is described and illustrated with respect to certain preferred and alternative embodiments, it should be understood that various modifications can be made to those embodiments without departing from the subject invention, the scope of which is defined in the following claims.

Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention

What is claimed is:

1. An artificial intelligence (AI) based performance analysis and sports training system comprising:
a robotic mechanical defender equipped with a camera, one or more sensors and one or more actuator to simulate defensive actions; and further comprising an advanced robotics components and the sensors for precise movement of the robotic mechanical defender;
a machine learning unit configured to analyze sensor data and predict player actions in real-time;
a real-time processing unit to execute decision-making algorithms and computer vision algorithms;
a striker scan and analysis tool for collecting and analyzing historical performance data of striker players;
an AI-driven training tool for generating personalized training based on striker scan and movement of the robotic mechanical defender and providing a real-time feedback to the striker;
an adaptive AI coaching module for delivering personalized coaching advice based on real-time performance and feedback data from AI driven training tool; and
wherein the machine learning unit and adaptive AI coaching module collaborate to adjust training regimens and coaching advice dynamically based on real-time sensor data from robotic mechanical defender for improving the performance of the striker in real match.

2. The artificial intelligence (AI) based performance analysis and sports training system of claim 1 comprises of block chain technology to securely store encrypted performance data, training progress, and injury history in a decentralized ledger, ensuring immutable records, transparent access controls, automated smart contract execution for incentives, and cryptographic data verification, thereby enhancing transparency, integrity, and accountability within the sports training ecosystem.

3. The artificial intelligence (AI) based performance analysis and sports training system of claim 1, further comprising:
a user interface featuring an intuitive dashboard that provides coaches and players with real-time analytics and AI-generated insights into gameplay strategies and performance metrics;
wherein, the intuitive dashboard facilitates immediate feedback on tactical decisions and player actions during training sessions;
configured to simulate various types of offensive plays and player actions to provide realistic training scenarios and improving player performance by providing challenging environment; and further
enables comprehensive analysis of team dynamics and individual player development, empowering coaches to customize training sessions based on specific skill areas, tactical adjustments, and strategic improvements.

4. The artificial intelligence (AI) based performance analysis and sports training system of claim 1, further comprising a cloud-based analytics platform to centralize and analyze training data from multiple different sources.

5. The artificial intelligence (AI) based performance analysis and sports training system of claim 1, wherein the AI-driven training tools simulate game scenarios and provides instant feedback using a screen on player performance to enhance skill development.

6. The artificial intelligence (AI) based performance analysis and sports training system of claim 1, further comprising gesture recognition technology to track and analyze player and ball movements.

7. A method for artificial intelligence (AI) based performance analysis and sports training, comprising:
collecting real-time sensor data from camera, one or more sensor and actuators in a robotic mechanical defender;
analyzing the collected sensor data with machine learning algorithms and predict player action;
collecting and analyzing striker data from historical performances and determining the side, shape, height, shot speed, and turn on the ball by the player;
generating personalized feedback and coaching advice based on the analyzed data and shot output;
providing player with individualized skill development plans and real-time feedback during training sessions with AI driven training tool and coaching module.

8. The artificial intelligence (AI) based performance analysis and sports training method of claim 7, further comprising the step of using a mechanical robotic defender to simulate defensive actions and pose challenging scenarios for player during training drills.

9. The artificial intelligence (AI) based performance analysis and sports training method of claim 7, further comprising the step of simulating offensive plays using a robotic defender to provide realistic training scenarios for defensive players and proving realistic training scenario for offensive players.

10. The artificial intelligence (AI) based performance analysis and sports training method of claim 7, further comprising the step of using striker scan and analysis tools to develop probability models based on historical performance data of offensive players and real-time sensor data.

11. The artificial intelligence (AI) based performance analysis and sports training method of claim 7, wherein the adaptive AI coaching module interacts with player to deliver personalized coaching advice and adjust training plans based on real-time performance feedback.

12. The artificial intelligence (AI) based performance analysis and sports training method of claim 7, wherein the collected performance data includes metrics such as speed, accuracy, direction, judgement, reaction time, and decision-making proficiency.

13. The artificial intelligence (AI) based performance analysis and sports training method of claim 7, further comprising the step of integrating virtual reality or augmented reality to create immersive training environments for player.

14. A robotic mechanical defense wall for training free-kicks or spot kicks, comprising:
a robotics mechanical defender equipped with a camera, a plurality of sensors and actuators to simulate defensive actions;
a real-time processing unit configured to execute defensive maneuvers based on sensor input;
a machine learning module for analyzing shot and historical performance data of a striker and predicting offensive player actions;
an AI-driven training tool for generating personalized training based on striker scan and movement of the robotic mechanical defender and providing a real-time feedback to the striker; and
an adaptive AI coaching module that provides personalized feedback and training recommendations based on real-time performance data and historical performance data.

15. The robotic mechanical defense wall apparatus for training free-kicks or spot kicks of claim 14, wherein the adaptive AI coaching module utilizes natural language processing to facilitate interactive coaching sessions and provide detailed, personalized advice to player.

16. The robotic mechanical defense wall apparatus of claim 14, wherein the sport can be any sport related to ball game such as Football, Hockey, Soccer or any other ball game.

17. The robotic mechanical defense wall apparatus of claim 14, wherein the robotic mechanical defender poses a challenging scenario for the player practicing in the training game.

18. The robotic mechanical defense wall apparatus of claim 14, wherein the robotic mechanical defender utilizing actuators to move head, legs for jump or no jump movement.

19. The robotic mechanical defense wall apparatus of claim 14, wherein technologies such as Artificial Intelligence, Robotics, Machine Learning and Computer vision in determining ball movement, striker's foot direction or movement, speed of ball, curve on the ball and generate reaction from the robotic mechanical defender to stop or divert the shot.

20. The robotic mechanical defense wall apparatus of claim 14, wherein the size of the robotic mechanical defender can be increased or decreased based on the opponent, a striker is preparing against and the robotic mechanical defender in the wall can act individually or collectively.
